(19) United States
(12) Patent Application Publication
(10) Pub. No.: US 2004/0094149 A1
(43) Pub. Date: May 20, 2004

(54) Pulmonary function filter, pulmonary sensor combination and components thereof

(75) Inventor: Vickie Natale, San Clemente, CA (US)

Correspondence Address: HENRICKS SLAVIN AND HOLMES LLP, SUITE 200, 840 APOLLO STREET, EL SEGUNDO, CA, 90245

(73) Assignee: Creative Biomedics, Inc.

(21) Appl. No.: 10/295,780

(22) Filed: Nov. 14, 2002

(51) Int. Cl. A62B 18/08

(52) U.S. Cl. 128/201.13

(57) ABSTRACT

A pulmonary function filter includes an adapter, which maybe resilient, allowing the filter to be used on a pulmonary function sensor having a different sized inlet. A pulmonary function sensor and filter combination can be joined by an adapter that may allow such sensor and filter to be joined even though they may have different sized inlet and outlet.

### BACKGROUND OF THE INVENTIONS

1. Field of the Inventions

This relates to pulmonary function filters and pulmonary sensor assemblies.

2. Related Art

Spirometry is the measurement of the volume of air entering and leaving the lungs, which measurements may indicate typical or impaired lung function. Such measurements may also be used to indicate changes in lung function, such as may occur as a result of an asthma condition. Spirometry systems can measure, record and assess flow/volume parameters, and such systems can tabulate, plot and display the desired pulmonary function information based on the measured parameters.

The equipment used in spirometry may include a pneumotachometer sensor for measuring lung function coupled to a microprocessor for analyzing data and/or for transmitting data to another site. Users exhale into the pneumotachometer through a mouth piece, and the pneumotachometer translates the exhale flow and time information into electronic data for analysis, display, storage or transmission. The pneumotachometer may be reusable, while the mouth piece is be typically disposable.

Typical pulmonary function measurement systems use a single-use, disposable filter between the mouth piece and the sensor. The filter is intended to prevent cross contamination by removing moisture droplets and bacteria from the respiratory air before the air reaches the sensor. The filter is preferably relatively short along the flow axis to minimize the amount of dead air in the flow path so that the space occupied by the filter has a minimum effect on the flow being sensed by the sensor. On the other hand, the diameter or cross-sectional area of the filter material is preferably relatively large so as to reduce any impediment to free air flow through the filter.

Sensors, as well as the filters used with the sensors, come in a number of shapes and sizes, and the sizes of the sensor inlets to which the filter outlets are attached vary as well. As a result, filters are made to have different outlet sizes to accommodate the different sensor inlet sizes. Likewise, any given filter generally can be used only with sensors having the appropriate sized inlet opening, and not with others without the use of an adapter. Use of a filter having an outlet not properly sized to fit the sensor inlet may result in leakage of air flow around the filter-sensor connection, leading to inaccurate results. Additionally, filter-sensor connections through hard plastic materials may not always provide the desired airtight seal.

### SUMMARY OF THE INVENTIONS

An adapter is provided for use between a pulmonary function filter and a sensor. The adapter may allow filters having different outlet sizes to be used on a given sensor. In one form, the adapter may allow a filter having a given outlet size to be used on sensors having different inlet sizes. The adapter may also contribute to an enhanced airtight seal for the filter and/or sensor.

In one example, a pulmonary function filter includes an adapter having a portion extending radially inward to form an opening for receiving an inlet of a sensor. The radially extending portion would then extend around the sensor inlet, preferably forming an airtight seal around the sensor inlet. In one example, the radially extending portion is flexible to accommodate sensor inlets of different sizes and/or shapes. In another example, the radially extending portion is resilient so as to be biased toward the outer surface of the sensor inlet, contributing to the formation of an airtight seal.

In another example, a pulmonary function filter includes a seal element on an outlet to form a seal about an inlet of a sensor. In one form, the seal element forms an airtight seal about the sensor inlet. The seal element can be formed from a resilient or flexible material, and in one preferred form is formed from an elastomeric material, such as may be suitable for equipment used in conjunction with pulmonary function analyzers.

In a further example, a pulmonary function filter includes an adapter formed from a resilient material, wherein the adapter is configured to fit around an inlet of a sensor. In one form, the adapter includes a portion extending radially toward a center so as to form an opening, for example a circular opening and/or an opening that is coaxial with a central axis of the filter. In one form, the adapter may be removable, and in another form the adapter may be bonded, welded, co-molded or otherwise fixed to the filter.

In another example, a sensor combination of a pulmonary function filter and a pulmonary function sensor includes an adapter having a first sleeve extending about a surface of the filter outlet and a second adapter element extending about an inlet on the sensor. In one form, the adapter is formed from the resilient material, and preferably forms an airtight seal about the outlet of the filter and the inlet of the sensor. The filter outlet may have a first diameter and the sensor inlet may have a second diameter less than the filter outlet diameter, and the second adapter element may extend radially inward to engage the sensor outlet. In one preferred form, the adapter is formed entirely from a resilient material, and may be formed as a single, monolithic component.

Aspects of the inventions are set forth more fully below in conjunction with drawings, a brief description of which follows.

### BRIEF DESCRIPTION OF THE DRAWINGS

FIG. 1 is a side elevation view of a pulmonary function sensor combination having a sensor, pulmonary function filter and mouth piece.

FIG. 2 is an isometric view of a pulmonary function filter for use with the combination of FIG. 1.

FIG. 3 is a longitudinal cross-section of the pulmonary function filter of FIG. 2.

FIG. 4 is an isometric view of a pulmonary function filter and adapter for use with the combination of FIG. 1.

FIG. 5 is an outlet end plan view of the pulmonary function filter combination of FIG. 4.

FIG. 6 is a longitudinal cross-section of the adapter of FIG. 4.

FIG. 7 is an end plan view of the adapter of FIG. 6.

### DETAILED DESCRIPTION

The following specification taken in conjunction with the drawings sets forth the preferred embodiments of the present inventions in such a manner that any person skilled in the art can make and use the inventions. The embodiments of the inventions disclosed herein are the best modes contemplated for carrying out the inventions in a commercial environment, although it should be understood that various modifications can be accomplished within the parameters of the present inventions.

A pulmonary function filter is described that includes an adapter enabling the filter to be placed on a sensor whose inlet size was such that the sensor would not previously have accommodated the filter. The filter can also be used on sensors for which it has previously been used.

Pulmonary function filters and the sensors with which they are used can take a number of configurations, sizes and shapes. The filter described herein will be one similar to that manufactured by Creative Biomedics, and discussed in U.S. Pat. No. 6,131,573, incorporated herein by reference. The pneumotachometer referenced herein may be any sensor that accommodates a pulmonary function filter, and may be one such as that marketed by Creative Biomedics with their DX-PC spirometry system. However, it should be understood that the present inventions can be used with a number of filters and a number of sensors other than the specific ones mentioned. The specific ones mentioned herein will be discussed as examples only, and it will be understood that the inventions are applicable to other designs.

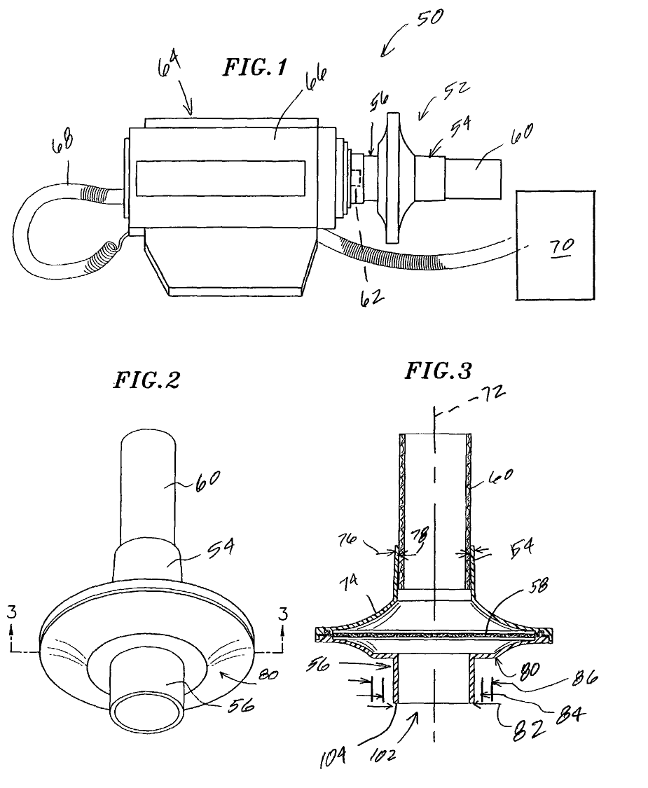

A pulmonary function analysis system or combination 50 (FIG. 1) in the example described herein includes a pulmonary function filter 52 with an inlet 54, an outlet 56 and a filter element 58 (FIG. 3) supported and positioned between the inlet and the outlet. An example of the pulmonary function filter shown in FIG. 3 is discussed in U.S. Pat. No. 6,131,573. A mouth piece 60 (FIG. 1) is typically inserted into the inlet 54 so that a user can force an expiratory breath into the filter.

The outlet 56 of the filter 52 is coupled to an inlet 62 of a sensor 64 (FIG. 1) so that the sensor 64 receives the exhaled air. The outlet of the filter is positioned adjacent, and may be disposed partly around the inlet 62 of the sensor. The sensor will typically include a housing 66 containing within it a material (not shown) for generating a slight pressure drop across the material, and several sensors or transducers at the upstream and downstream sides of the material for detecting the pressure differential across the material. The transducers generate electrical signals representing the pressure differential, which signals are then transmitted over an appropriate cable 68 to a microprocessor or other controller 70 for receiving the data and combining it with other data to be used in the analysis. The controller may include appropriate software for analyzing the data and generating the desired representations of the data, such as a flow/volume curve, tabulated data or other information for the user, a practitioner or other personnel. The controller may also include a display, printer, data entry keys, control keys such as calibration keys and the like, ports for communicating with other devices, as well as other components.

The pulmonary function filter (FIGS. 1-5) is preferably symmetrical about a central longitudinal axis 72 and includes a first housing portion 74 having the inlet 54 extending along the axis toward an end into which the mouth piece is inserted. The inlet has a first outside diameter 76 and an inside diameter 78 (FIG. 3), wherein the outside diameter of the mouth piece 60 is approximately the same as the inside diameter 78 to provide a friction fit. The engagement between the mouth piece 60 and the inside diameter 78 of the inlet 54 is preferably airtight.

The filter includes a second housing portion 80 joining with the first housing portion 74 in such a way as to preferably sandwich the filter material 58 between them. The axial length of the filter is preferably small so as to minimize dead air space between the inlet and the outlet, while the surface area of the filter element is preferably relatively large in the radial direction to keep low the resistance to air flow. The second housing portion 80 includes the outlet 56, which has an outside diameter shown in FIG. 3 at 82. The outlet is typically cylindrical, forming a right circular cylinder to the point where the outlet 56 joins the rest of the second housing portion 80 and is preferably coaxial with the center axis 72 and the inlet. The outer most portion of the outlet is preferably circular in cross-section. Other pulmonary function filters may have an outlet having an intermediate outside diameter 84 while others may have a larger outside diameter 86, these other outside diameters represented schematically by the lines shown in FIG. 3. It should be understood that the wall thickness of the outlet for any given outside diameter would generally be the same for any given filter, the outer lines shown around the outlet of the filter in FIG. 3 being used to represent the other outlets for simplicity. The filter used with the adapter described herein preferably has a larger outlet diameter, such as that corresponding to be outside diameter 86 (FIG. 3), and one which is larger than the diameter of the filter inlet. The larger outlet diameter enables it to be placed around the outlets of a larger number of sensors.

The housing portions of the filter are typically formed of a relatively hard or rigid plastic, such as styrene, but other materials may be used such as polypropylene and other plastics. Additionally, the filter can have other shapes and dimensions, and the filter element can be supported in other ways.

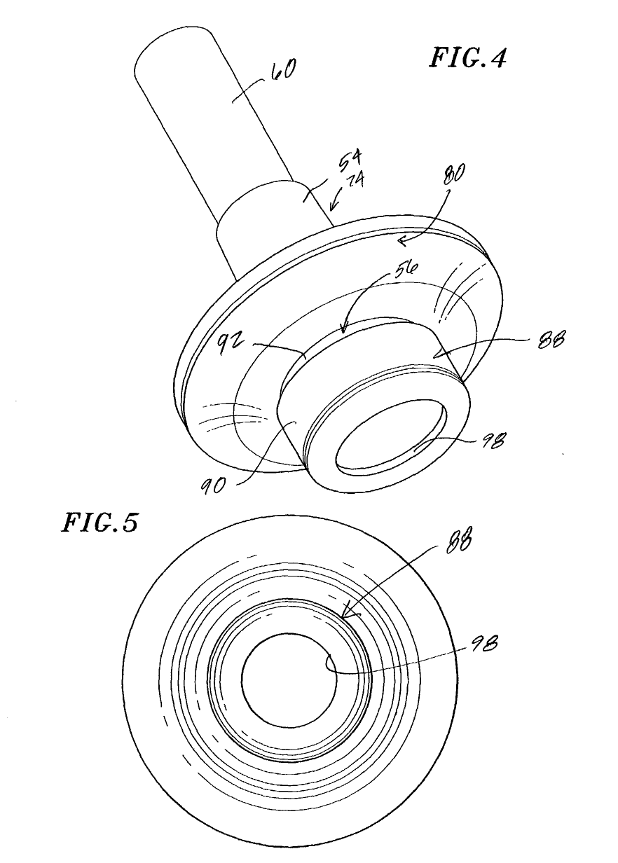

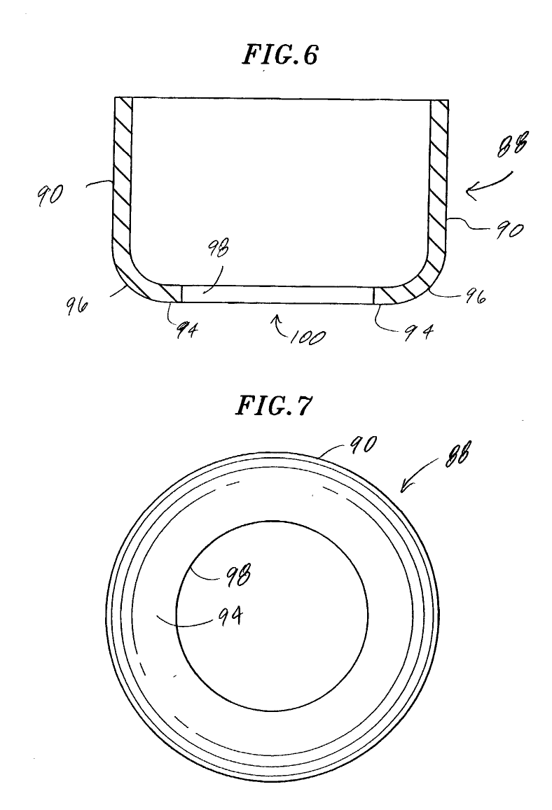

An adapter, junction, interface or seal element 88 (FIGS. 4-7) is used to couple the filter to the sensor. In the example shown in FIGS. 4-7, the adapter includes a first wall portion or sleeve 90 extending axially along the wall 92 of the outlet 56 (FIG. 4) a sufficient distance to form a reliable airtight seal between the first wall portion 90 and the wall 92. A second portion or second element 94 extends radially inward in the direction of the central axis 72 (not shown in FIG. 6). The second portion 94 extends inwardly from a transition portion 96 to a wall 98 forming an opening 100 confluent with the opening 102 in the outlet 56 (FIG. 3). The wall 98 preferably forms an airtight seal about the outer surface of the sensor inlet 62. In one example, the second portion 94 is formed from a resilient soft plastic to adequately grip the outer surface of the inlet 62. In another example, the wall 98 or other surface of second portion 94 that contacts the surface of the inlet 62 has a surface that is sufficiently tacky to form the desired airtight seal. Other surfaces besides wall 98 may contact the surface of the inlet 62, depending on how the filter and adapter are manipulated onto the inlet 62, for example through rotation, axial sliding, or both, and on the sensor inlet size.

The opening 100 is preferably circular as shown in FIGS. 4-7. While other configurations of the opening are possible, many sensor inlets 62 are round and could be accommodated by round openings 100. In the example shown in the drawings, the shape of the opening 100 conforms to the outer shape of the sensor 62. The dimensions of the opening 100 as defined by the wall 98 may be smaller than the smallest outside diameter of sensor inlet 62 to which the filter will be attached. In one example, the adapter wall 90 contacts the surface 92 of the outlet over a given surface area, and the second portion and/or wall 98 contact the sensor inlet 62 over a surface area less than the surface area of contact over the filter outlet. These relative surface areas may enhance the ability of the adapter to remain in the proper position on the outlet 56. In the example where the adapter 88 is placed on the outlet having the larger outside diameter 86, and the size of the opening 100 is less than the smallest outside diameter of inlet 62, the filter can be used on sensors having a range of diameters for the inlet 62. Consequently, the number of different sizes of filters made and stocked can be reduced, thereby reducing part inventory, manufacturing costs, and the like.

In the example shown in FIGS. 4-5, the adapter 88 is a discrete monolithic structure placed over part of the outside wall 92 of the outlet 56. In this example, the inside diameter of the wall 90 in its relaxed configuration is preferably less than the outside diameter of the outlet 56 so that the inside surface of the wall 90 grips or frictionally engages the outside surface of the wall 92. In this example, the adapter 88 can be removable from the filter. In another example, the seal element can be bonded, glued, adhered, welded, dissolved or otherwise fixed to the outlet 56. The adapter could also be heat-shrunk onto the wall of the outlet. The wall 90 could extend over a substantial portion of the wall 92, a relatively short portion of the wall 92, or could extend only across the rim 104 (FIG. 3) of the outlet. In a further example, the adapter can be monolithic with the second housing 80. In this further example of the monolithic adapter, the adapter is preferably formed from a different material than the second housing 80, and may be co-molded with the second housing. The adapter may be a plastic sufficiently soft, resilient and/or flexible to form an airtight seal around one and preferably both of the outlet 56 and the inlet 62. The adapter can be a thermoplastic elastomer, for example rubber, Neoprene, or other suitable thermoplastic materials.

The adapter 88 is used to join the filter to the inlet 62 of the sensor, and preferably provides an airtight seal between the filter and the sensor. In one example, the adapter 88 forms an airtight seal with the outlet 56 and forms an airtight seal around the inlet 62. In the example shown in FIG. 4, the adapter 88 forms an airtight seal around the outlet wall 92.

Having thus described several exemplary implementations of the invention, it will be apparent that various alterations and modifications can be made without departing from the inventions or the concepts discussed herein. Such operations and modifications, though not expressly described above, are nonetheless intended and implied to be within the spirit and scope of the inventions. Accordingly, the foregoing description is intended to be illustrative only.

What is claimed is:

1. A pulmonary function filter comprising:
a housing containing a filter material and having an inlet and an outlet, the outlet having a wall defining an opening; and
a seal element supported by the wall of the outlet and forming an airtight seal between the seal element and the wall, wherein the seal element includes a first portion extending along the wall of the outlet and a second portion extending radially toward a center of the opening and terminating at a wall defining a second opening.

2. The filter of claim 1 wherein the outlet is larger than the inlet.

3. The filter of claim 2 wherein the outlet opening is circular.

4. The filter of claim 1 wherein the seal element is removable from housing.

5. The filter of claim 1 wherein the seal element is monolithic with the housing.

6. The filter of claim 5 wherein the seal element is co-molded with the housing.

7. The filter of claim 1 wherein the housing is a hard plastic and the seal element is a flexible and resilient element.

8. The filter of claim 1 wherein the seal element is bonded to the housing.

9. The filter of claim 1 wherein the housing includes first and second housing portions and wherein the filter material is held between the first and second housing portions.

10. The filter of claim 9 wherein the filter material has edge portions and wherein the edge portions are sandwiched between the first and second housing portions.

11. The filter of claim 1 wherein the housing includes a central axis and the inlet and the outlet are coaxial with the second opening.

12. The filter of claim 1 wherein the second opening is smaller than the outlet opening.

13. The filter of claim 12 wherein the second opening is circular.

14. A sensor combination having a pulmonary function filter with an inlet, an outlet and a filter element supported and positioned between the inlet and the outlet, wherein the filter is mounted to an inlet of a pulmonary function sensor through an adapter, the improvement comprising a first sleeve on the adapter extending about a surface of the filter outlet and a second adapter element on the adapter extending about the sensor inlet.

15. The combination of claim 14 wherein the adapter is formed from resilient material.

16. The combination of claim 15 wherein the first sleeve on the adapter extends about the surface of the filter outlet and axially along the surface.

17. The combination of claim 16 wherein the adapter is bonded to the surface of the filter outlet.

18. The combination of claim 16 wherein the second adapter element contacts the sensor inlet over a first surface area less than a surface area over which the first sleeve on the adapter contacts the surface of the filter outlet.

19. The combination of claim 14 wherein the filter outlet has a first diameter and the sensor inlet has a second diameter less than the first diameter.

20. The combination of claim 14 wherein the adapter forms an airtight seal around the filter outlet and around the sensor inlet.

21. The combination of claim 14 wherein the filter housing is formed from a rigid material and the adapter is formed from a resilient material.

22. The combination of claim 21 wherein the adapter is formed exclusively from the resilient material.

23. The combination of claim 14 wherein the filter outlet and the sensor inlet are adjacent each other.

24. The combination of claim 23 wherein the sensor inlet extends partly into the filter outlet.

25. An inhalation sensing system comprising:
a pulmonary function filter having a housing containing a filter element and having an inlet and an outlet with the filter element in between, and wherein the outlet includes a wall defining an opening;
a pulmonary function sensor having an inlet; and
a resilient adapter having a first cylindrical portion forming an airtight seal around the filter outlet and a second portion forming an airtight seal around the sensor inlet.

26. The system of claim 25 wherein the second portion is integral with the first cylindrical portion.

27. The system of claim 26 wherein the first cylindrical portion includes a first outside diameter and the second portion includes a second outside diameter smaller than the first diameter.

28. The system of claim 27 wherein the sensor inlet extends partly inside the filter outlet.

29. A pulmonary sensor combination comprising:
a pulmonary function filter having a housing with an inlet and an outlet and a filter element supported by the housing between the inlet and the outlet;
a pulmonary sensor device having an inlet; and
means for coupling the filter outlet to the sensor inlet wherein the coupling means is formed from a resilient material, extends around and outside the filter outlet, and extends around and outside the sensor inlet.

30. The combination of claim 29 wherein the coupling means is formed from an elastomeric material.

31. The combination of claim 30 wherein the coupling means forms an airtight seal around the filter outlet and around the sensor inlet.

32. The combination of claim 31 wherein the coupling means is bonded to the filter housing.

33. The combination of claim 31 wherein the coupling means is monolithic with the filter housing.

34. The combination of claim 31 wherein the filter housing is rigid.

35. The combination of claim 31 wherein the filter outlet has a first diameter and the sensor inlet includes a second diameter smaller than the first diameter.
